(19) United States
(12) Patent Application Publication
(10) Pub. No.: US 2009/0051089 A1
(43) Pub. Date: Feb. 26, 2009

(54) Damping Element in the Form of a Cylindrical Hollow Body and Method of Production

(75) Inventors: Claus Kirchner, Porta Westfalica (DE); Mark Langner, Bielefeld (DE)

Correspondence Address: LERNER GREENBERG STEMER LLP, P O BOX 2480, HOLLYWOOD, FL, 33022-2480, US

(73) Assignee: MOLLERMINER GmbH, Delbruk (DE)

(21) Appl. No.: 12/189,249

(22) Filed: Aug. 11, 2008

(30) Foreign Application Priority Data
Aug. 11, 2007 (DE) 10 2007 037 954.6

(51) Int. Cl. F16F 7/00; B23P 19/04

(52) U.S. Cl. 267/141; 29/454

(57) ABSTRACT

A damping element shaped as a cylindrical hollow body having an end-side stop and a wall surrounding the body with annular flanges extending around the wall spaced relative to one another. The annular flanges and the wall between the annular flanges have different thicknesses. A method for producing the damping element, includes first producing a blank of the cylindrical hollow body and subsequently upsetting the body to simultaneous shorten it in the direction of the upsetting force by at least 20% of its original length. Then, the walls of the cylindrical hollow body are convexly arched between the annular flanges to form a bellows-like configuration.

Damping element in the form of a cylindrical hollow body, and production method

The invention relates to a damping element in the form of a cylindrical hollow body, having an end-side stop and annular flanges which run around on the wall with a spacing to one another, and to a method for producing a damping element.

The known damping elements have proven themselves in practical applications. Here, the annular flanges serve to guide the damping element and to provide stabilization under loading. The upper part is to be considered to be a damping region, while the lower region serves as a stop. Here, the annular flanges and the walls of the cylindrical hollow body between said annular flanges have identical thicknesses in each case.

The object on which the invention is based is that of improving the damping properties of the damping element using simple structural measures.

Said object is achieved according to the invention in that the annular flanges and the wall between the annular flanges have different thicknesses. The inner delimitation of the wall and the outer delimitations of the annular flanges expediently run vertically. For the majority of applications, it has proven to be advantageous to arrange three annular flanges. It is directly possible to arrange more or fewer annular flanges and also to adapt the thickness of the walls of the hollow body between the flanges and the thickness of the annular flanges to the respective requirements.

In one refinement of the invention, the stop has a cylindrical hollow shape and is pressed into the cylindrical hollow body, with it being possible for the lower delimitation to run in a plane with the lower delimitation of the cylindrical hollow body.

The end-side stop may be embodied as a mechanical stop delimitation or as a flexible stroke delimitation. The mechanical stop is expediently formed from a solid material, for example from hard plastic or metal. In one embodiment of the invention, the end-side mechanical stop has a locking element, for example an encircling annular bead, which is assigned corresponding receptacles on the inner side of the cylindrical hollow body. It is possible to design the flexible stroke delimitation ≧the thickest wall of the cylindrical hollow body between the annular flanges.

In one preferred embodiment, the cylindrical hollow body with its annular flanges is formed in one piece from elastically deformable material, and may be produced in an injection-molding process or cutting process. One of the outer annular flanges or both annular flanges advantageously have an additional hollow body which has an encircling chamfer on the upper inner side.

In the method according to the invention for producing a damping element, firstly the blank of the cylindrical hollow body is produced and subsequently upset so as to undergo simultaneous shortening in the direction of the upsetting force by at least 20% of its original length. Here, the walls of the cylindrical hollow body between the annular flanges are convexly arched between the flanges, resulting in a bellows-like design being created. The thickness of the arching runs uniformly in the region between the annular flanges and symmetrically about the axial central line of the cylindrical hollow body. The shortening of the cylindrical hollow body which is generated as a result of the upsetting processes is maintained even after the release of the upsetting force.

According to a further feature of the method according to the invention, during the upsetting process of the blank of the cylindrical hollow body, the stop which is composed of solid material is pressed into the hollow body and is retained therein in a form-fitting manner. The flexible stroke delimitation may be inserted with a slight oversize with respect to the hollow body, and, like the bellows-like arching between the annular flanges, has an internal stress imparted to it during the upsetting process, which internal stress is caused by the stretching of the molecule chains.

Exemplary embodiments of the invention are illustrated in the drawing and are described below. In the drawing:

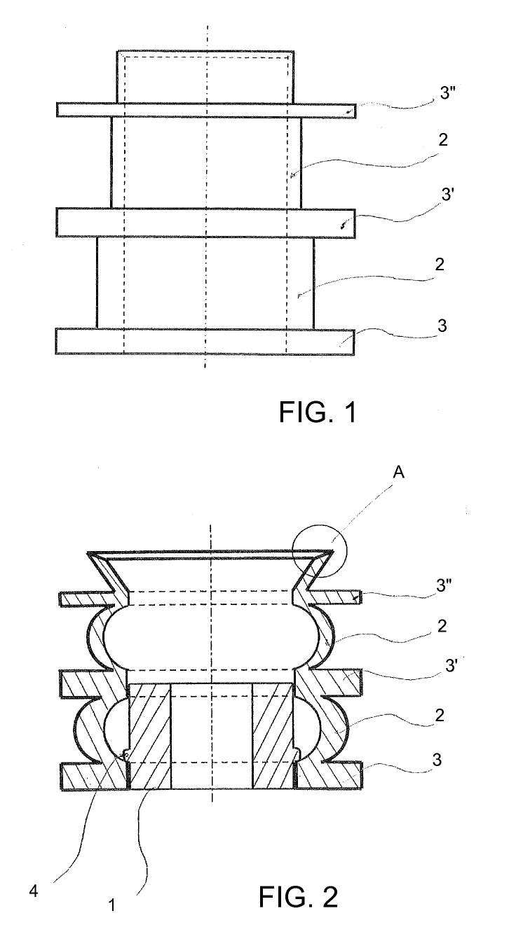

FIG. 1 shows a view of a blank of a cylindrical hollow body;

FIG. 2 shows a vertical section through a damping element after the upsetting process, with a mechanical stop;

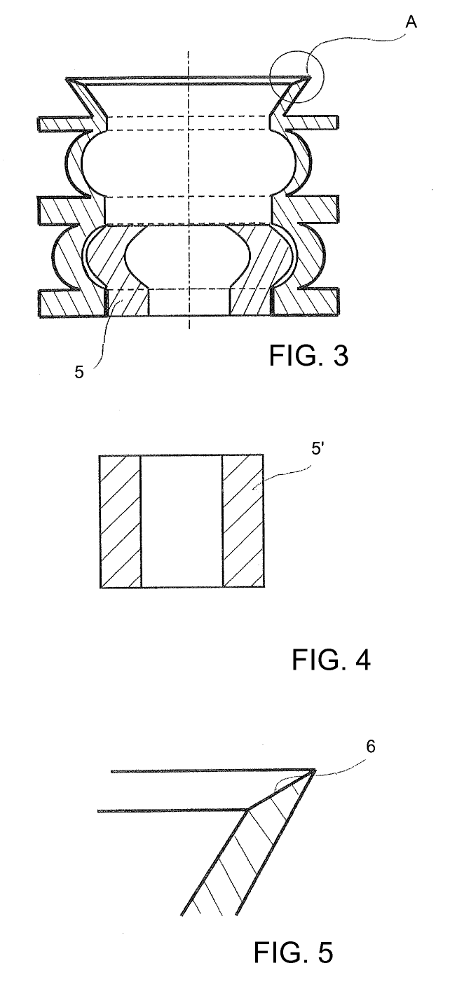

FIG. 3 as FIG. 2, but with a flexible stop as a stroke delimitation;

FIG. 4 shows a vertical section through a blank of the flexible stroke delimitation, and

FIG. 5 shows an enlarged illustration of the point A.

The illustrated damping element in the form of a hollow body has three annular flanges 3; 3′; 3″. Said annular flanges 3; 3′; 3″, like the wall 2 between said flanges, have different thicknesses. The outer delimitation of the three annular flanges 3; 3′; 3″ are situated vertically one above the other. Said annular flanges 3; 3′; 3″ may however also have different delimitations.

In FIG. 2, a mechanical stop in the form of a cylindrical hard plastic hollow body 1 is pressed in in the lower region of the damping element. Said cylindrical hollow body 1 has an encircling outer annular bead 4 as a latching element. Said annular bead 4 is assigned corresponding receptacles on the inner side of the cylindrical hollow body. As illustrated, the lower delimitation of the hard plastic hollow body 1 runs in a plane with the lower delimitation of the cylindrical hollow body, which is formed in one piece from elastically deformable material.

A variant of the end-side stop is illustrated in FIG. 3. Instead of a pressed-in hard plastic hollow body 1, a flexible stop delimitation 5 is arranged as a stop, with the flexible stroke delimitation 5 having a thickness which is ≧the thickest wall between the annular flanges. The thickness of the flexible stroke delimitation 5 may, if required, also be ≧the thickest wall between the annular flanges 3; 3′; 3″. As a result of the upsetting of the cylindrical hollow body, the flexible stroke delimitation 5 is deformed and is thereby retained in a form-fitting manner.

The upper delimitation of the cylindrical hollow body has an encircling chamfer 6 which serves such that it can be formed as the highest annular delimitation symmetrically on the outer side during the upsetting process.

### LIST OF REFERENCE SYMBOLS

1 Hard plastic hollow body (stop)
2 Wall
3 Annular flange
3′ Annular flange
3″ Annular flange
4 Annular bead (locking element)
5 Flexible stroke delimitation (deformed)
5′ Flexible stroke delimitation (blank)
6 Chamfer

1-23. (canceled)

24. A damping element comprising a cylindrical hollow body, said body including an end-side stop and a wall surrounding said stop having annular flanges extending around said wall in spaced relation relative to each other, said wall being disposed between adjacent ones of said flanges, said annular flanges and said wall between said annular flanges having different thicknesses.

25. The damping element according to claim 24, wherein said wall has an inner delimitation that extends vertically.

26. The damping element according to claim 24, wherein said annular flanges have outer delimitations that extend vertically above each other.

27. The damping element according to claim 24, including at least two annular flanges.

28. The damping element according to claim 24, wherein said stop has a cylindrical hollow shape.

29. The damping element according to claim 24, wherein said stop and said hollow body are the same material.

30. The damping element according to claim 24, wherein a lower delimitation of said stop extends in a plane with a lower delimitation of said cylindrical hollow body.

31. The damping element according to claim 24, wherein said end-side stop is a mechanical stop delimitation.

32. The damping element according to claim 28, wherein said end-side stop comprises a solid material.

33. The damping element according to claim 32, wherein said stop comprises hard plastic.

34. The damping element according to claim 30, wherein said end-side stop includes locking elements.

35. The damping element according to claim 34, wherein said cylindrical hollow body includes receptacles on an inner side thereof for operatively engaging said locking elements.

36. The damping element according to claim 34, wherein said locking elements comprise an encircling annular bead.

37. The damping element according to claim 24, wherein said end-side stop has a flexible stroke delimitation.

38. The damping element according to claim 37, wherein the flexible stop delimitation has a thickness which is equal or greater than a thickest wall between said annular flanges.

39. The damping element according to claim 24, wherein said cylindrical hollow body comprises one piece of elastically deformable material.

40. The damping element according to claim 24, wherein said cylindrical hollow body is injection-molded.

41. The damping element according to claim 24, wherein said cylindrical hollow body has an upper delimitation which comprises an encircling chamfer.

42. The damping element according to claim 41, wherein said chamfer has a highest annular delimitation on an outer side of said hollow body.

43. A method for producing a damping element comprising a cylindrical hollow body, said body including an end-side stop and a wall surrounding said stop having annular flanges extending around said wall in spaced relation relative to each other, comprising the steps of:
first producing a cylindrical hollow body, and
thereafter upsetting the hollow body to simultaneously shorten the hollow body in a direction of an upsetting force by at least 20% of an original length of the hollow body.

44. The method according to claim 43, including the step during the upsetting step of pressing the stop of solid material into the hollow body and retaining the stop therein in a form-fitting manner.

45. The method according to claim 43, including the steps during the upsetting step of forming the stop in a bellows shape with a flexible stroke delimitation, pressing the stop into the hollow body, and retaining the stop therein in a form-fitting manner.

46. The method according to claim 43, including the step of convexly arching the walls of the cylindrical hollow body between the flanges to form a bellows-like configuration.
